(19) United States
(12) Patent Application Publication
(10) Pub. No.: US 2026/0245488 A1
(43) Pub. Date: Aug. 20, 2026

(54) WEARABLE ELECTRONIC DEVICE COMPRISING FLEXIBLE DISPLAY, AND OPERATING METHOD THEREOF

(71) Applicant: SAMSUNG ELECTRONICS CO., LTD., Suwon-si (KR)

(72) Inventors: Hyerim BAE, Suwon-si (KR); Jeongho KANG, Suwon-si (KR); Nahye KIM, Suwon-si (KR); Byoungjun KIM, Suwon-si (KR); Seungyong LEE, Suwon-si (KR); Jihea PARK, Suwon-si (KR)

(21) Appl. No.: 19/642,628

(22) Filed: Apr. 9, 2026

Related U.S. Application Data
(63) Continuation of application No. PCT/KR2024/012410, filed on Aug. 21, 2024.

(30) Foreign Application Priority Data
Oct. 13, 2023 (KR) 10-2023-0136897
Oct. 30, 2023 (KR) 10-2023-0146881

(51) Int. Cl. G09G 3/00; G01P 13/00; G06F 3/14

(52) U.S. Cl. CPC G09G 3/035; G01P 13/00; G06F 3/14; G09G 2354/00

(57) ABSTRACT

An electronic device includes: a housing; a flexible display in the housing; a strap attachable to a wrist of a user; a first sensor to sense the rotation of the electronic device when the electronic device rotates by a rotation of the wrist of the user; and a second sensor to sense a movement of the electronic device by a movement of an arm of the user; a processor; and a memory storing instructions therein. The instructions cause the electronic device to obtain a sensing value using the first or second sensor when the electronic device is attached to the wrist of the user, causes the electronic device to identify an event for requesting display of a screen, and causes the electronic device to control the display to display, based on the sensing value, a screen corresponding to the event in an area corresponding to the sensing value.

### CROSS-REFERENCE TO RELATED APPLICATIONS

This application is a continuation application, claiming priority under §365(c), of an International application No. PCT/KR2024/012410, filed on August 21, 2024, which claims priority to Korean Patent Application No. 10-2023-0136897, filed on October 13, 2023, and Korean Patent Application No. 10-2023-0146881, filed on October 30, 2023, and all the benefits accruing therefrom under 35 U.S.C. §119, the contents of which in their entireties are herein incorporated by reference.

### BACKGROUND

### (1) Field

The disclosure relates to a wearable electronic device including a flexible display and an operating method thereof according to an embodiment.

### (2) Description of the Related Art

To improve user convenience and enhance power efficiency of electronic devices, the usability of wearable electronic devices (e.g., smart watches) equipped with displays (e.g., bendable displays or flexible displays) is being researched.

### SUMMARY

According to an embodiment, an electronic device includes a housing, a flexible display arranged in the housing, a strap connected to the housing and configured to attach the electronic device to a wrist of a user, a first sensor configured to detect or identify the rotation of the electronic device when the electronic device is rotated based on the rotation of the wrist of the user, a second sensor configured to detect or identify the movement of the electronic device when the electronic device is moved based on the movement of an arm of the user, a processor, and memory storing instructions. The instructions are configured to, when executed by the processor, cause the electronic device to obtain a sensing value by using the first sensor or the second sensor in a state where the electronic device is attached to the wrist of the user by the strap. The instructions are configured to, when executed by the processor, cause the electronic device to identify an event requesting display of a screen on the display. The instructions are configured to, when executed by the processor, cause the electronic device to control the display to, based on the sensing value, display a screen corresponding to the event in an area corresponding to the sensing value among a plurality of areas of the display.

According to an embodiment, an operating method of an electronic device includes an operation of obtaining a sensing value by using a first sensor or a second sensor of the electronic device in a state where the electronic device is attached to a wrist of a user by a strap of the electronic device. The first sensor is a sensor configured to detect or identify the rotation of the electronic device when the electronic device is rotated based on the rotation of the wrist of the user. The second sensor is a sensor configured to detect or identify the movement of the electronic device when the electronic device is moved based on the movement of an arm of the user. The method further includes an operation of identifying an event requesting display of a screen on a display of the electronic device. The method further includes an operation of controlling the display to, based on the sensing value, display a screen corresponding to the event in an area corresponding to the sensing value among a plurality of areas of the display.

According to an embodiment, a computer readable recording medium storing instructions configured to cause a processor of an electronic device to perform at least one operation is provided, where the at least one operation includes an operation of obtaining a sensing value by using a first sensor or a second sensor of the electronic device in a state where the electronic device is attached to a wrist of a user by a strap of the electronic device. The first sensor is a sensor configured to detect or identify the rotation of the electronic device when the electronic device is rotated based on the rotation of the wrist of the user. The second sensor is a sensor configured to detect or identify the movement of the electronic device when the electronic device is moved based on the movement of an arm of the user. The at least one operation further includes an operation of identifying an event requesting display of a screen on a display of the electronic device. The at least one operation further includes an operation of controlling the display to, based on the sensing value, display a screen corresponding to the event in an area corresponding to the sensing value among a plurality of areas of the display.

### BRIEF DESCRIPTION OF THE DRAWINGS

FIG. 1 is a block diagram illustrating an electronic device in a network environment according to an embodiment.

FIG. 2 is a diagram illustrating an unfolded state of an electronic device according to an embodiment.

FIG. 3 is a diagram illustrating a fastened state of an electronic device according to an embodiment.

FIG. 4 is a diagram illustrating a worn state of an electronic device according to an embodiment.

FIG. 5 is a diagram illustrating a display direction of a screen of an electronic device according to an embodiment.

FIG. 6 is a block diagram illustrating an electronic device according to an embodiment.

FIG. 7A is a flowchart illustrating an operating method of an electronic device according to an embodiment.

FIG. 7B is a flowchart illustrating an operating method of an electronic device according to an embodiment.

FIG. 8 is a diagram illustrating a screen of a first area of a display according to an embodiment.

FIG. 9 is a diagram illustrating a screen of a first area of a display according to an embodiment.

FIG. 10 is a diagram illustrating a screen of a second area of a display according to an embodiment.

FIG. 11 is a diagram illustrating a screen of a second area of a display according to an embodiment.

FIG. 12 is a diagram illustrating a screen of a second area of a display according to an embodiment.

FIG. 13 is a diagram illustrating a screen of a second area of a display of an electronic device according to an embodiment.

FIG. 14 is a diagram illustrating a screen of a third area of a display according to an embodiment.

FIG. 15 is a diagram illustrating a screen of a third area of a display according to an embodiment.

FIG. 16 is a diagram illustrating a screen of a third area of a display according to an embodiment.

FIG. 17A is a flowchart illustrating an operating method of an electronic device according to an embodiment.

FIG. 17B is a diagram illustrating a display direction of a screen of an electronic device according to an embodiment.

FIG. 18A is a flowchart illustrating an operating method of an electronic device according to an embodiment.

FIG. 18B is a diagram illustrating a display area of a screen of an electronic device according to an embodiment.

FIG. 18C is a diagram illustrating a display area of a screen of an electronic device according to an embodiment.

FIG. 19 is a diagram illustrating display of screens of a plurality of areas of a display according to an embodiment.

FIG. 20 is a diagram illustrating display of screens of a plurality of areas of a display according to an embodiment.

FIG. 21 is a diagram illustrating display of a screen of an electronic device according to an embodiment.

FIG. 22 is a diagram illustrating display of a screen of an electronic device according to an embodiment.

FIG. 23 is a diagram illustrating display of a screen of an electronic device according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

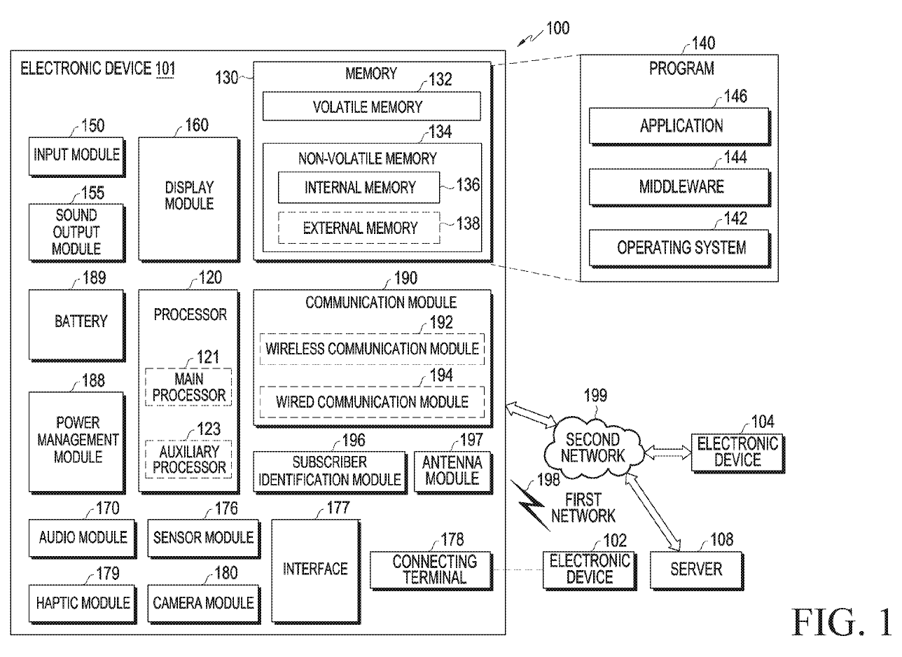

FIG. 1 is a block diagram illustrating an electronic device in a network environment according to an embodiment.

Referring to FIG. 1, an embodiment of the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, in an embodiment where the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing 1eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 is configured to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

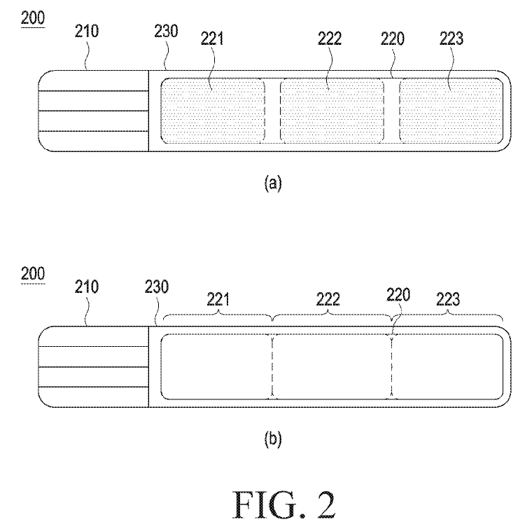

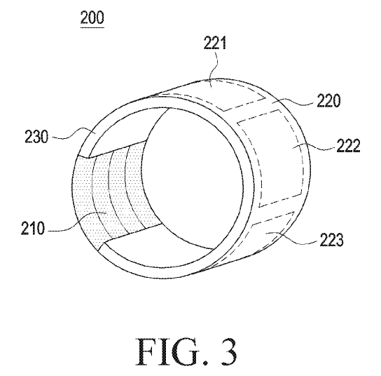

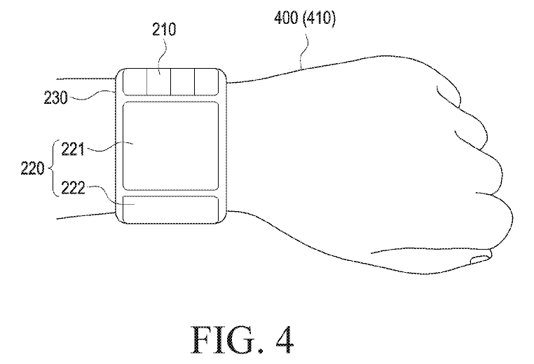

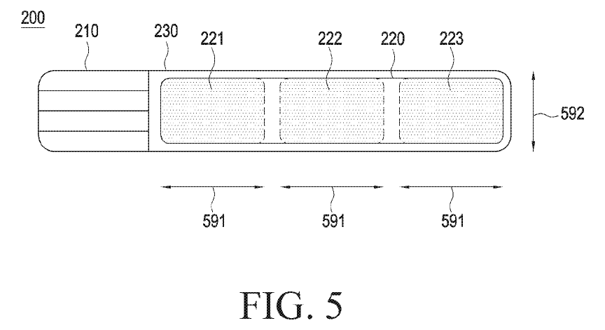

FIG. 2 is a diagram illustrating an unfolded (or unbent) state of an electronic device according to an embodiment. FIG. 3 is a diagram illustrating a fastened (or bent) state of an electronic device according to an embodiment. FIG. 4 is a diagram illustrating a worn state of an electronic device according to an embodiment. FIG. 5 is a diagram illustrating a display direction of a screen of an electronic device according to an embodiment.

The electronic device 200 in FIG. 2 may correspond to the electronic device 101 in FIG. 1. The electronic device 200 in FIG. 2 may include at least some of the components included in the electronic device 101 in FIG. 1. The operation of the electronic device 200 in FIG. 2 may be controlled by a processor (e.g., the processor 120 in FIG. 1). The electronic device 200 in FIG. 2 may include memory 130 that stores instructions. The instructions included in the memory 130 may be configured to, when executed by the processor 120, cause the electronic device 200 to perform at least one operation.

Referring to FIGS. 2, 3, 4, and 5, an embodiment of the electronic device 200 (e.g., a wearable electronic device (e.g., a smart watch)) that may be attachable to a body part 410 (e.g., a wrist) of a user 400 and includes a display 220 (e.g., a bendable display or a flexible display) will hereinafter be described.

According to an embodiment, the electronic device 200 may include a housing 230, a display 220, and a strap 210. The display 220 in FIG. 2 may be included in the display module 160 in FIG. 1.

According to an embodiment, the strap 210 may be connected to the housing 230. The strap 210 may be configured to attach the electronic device 200 to the body part 410 (e.g., the wrist) of the user 400. There is no limitation on the shape of the strap 210. In an embodiment, as shown in FIG. 2, one end of the strap 210 may be connected to the housing 230 and the other end of the strap 210 may be detachable from the housing 230, but this is merely an example, and there is no limitation on the implementation method of the strap 210. Although FIG. 2 illustrates a simplified connection structure between the strap 210 and the housing 230 for explanatory purposes the connection structure of the strap 210 and the housing 230 is not limited thereto. For example, the strap 210 of the electronic device 200 may be implemented to be similar to a strap included in a general watch. For example, the strap 210 (or a part of the strap 210) may be detachably attached to the housing 230 or may be implemented as an integral part with the housing 230. For example, the strap 210 may include components that are attachable to and detachable from each other. For example, the strap 210 may include an elastic material.

According to an embodiment, the display 220 (e.g., a bendable display or a flexible display) may be disposed in the housing 230. The display 220 may configure a flat plane in an unfolded state of the electronic device 200 as in FIG. 2, or may be bent in a fastened state of the electronic device 200 as in FIG. 3, or in a worn state of the electronic device 200 as in FIG. 4. According to an embodiment, the display 220 may include a plurality of areas (e.g., 221, 222, and 223).

The division and shape of the plurality of areas (e.g., 221, 222, and 223) of the display 220 in FIG. 2 are merely examples, and there is no limitation on the method of division of the plurality of areas (e.g., 221, 222, and 223) and the shape of the plurality of areas (e.g., 221, 222, and 223). For example, the plurality of areas (e.g., 221, 222, and 223) of the display 220 may be divided with a gap therebetween or may be divided adjacent to each other. The other drawings below illustrate that the plurality of areas (e.g., 221, 222, and 223) of the display 220 are spaced apart from each other, as in part (a) of FIG. 2, but this is for convenience of explanation. In the drawings below, the plurality of areas (e.g., 221, 222, and 223) of the display 220 may be areas spaced apart from each other, as in part (a) of FIG. 2, or may be adjacent areas, as in part (b) of FIG. 2. In an embodiment, as shown in FIG. 2, the plurality of areas (e.g., 221, 222, and 223) of the display 220 may be divided into three areas, but this is only an example, and there is no limitation on the number of the plurality of areas of the display 220. For example, the plurality of areas of the display 220 may be divided into two areas, four areas, or more areas.

According to an embodiment, referring to FIGS. 2 and 3, the display 220 may include a first area 221, a second area 222, and a third area 223. The first area 221 of the display 220 may be an area adjacent to a first end of the strap 210. The third area of the display 220 may be an area adjacent to a second end of the strap 210. The second area 222 of the display 220 may be an area adjacent to the first area 221 and the third area 223.

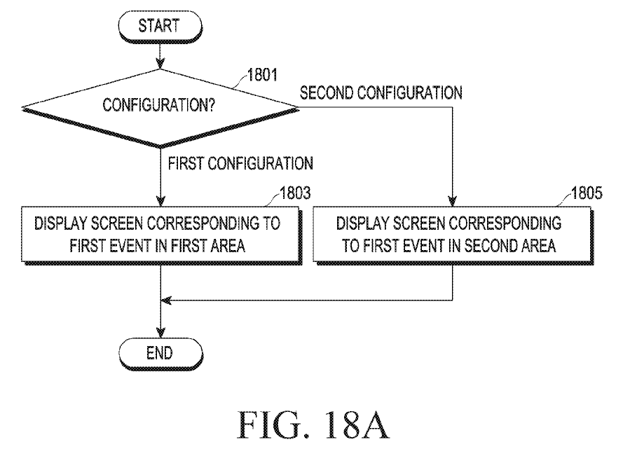

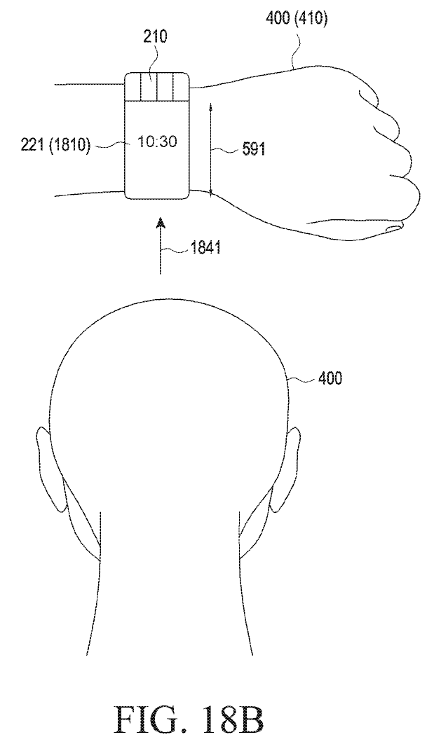

Referring to FIGS. 3 and 4, a state in which the electronic device 200 is attached to the body part 410 (e.g., the left wrist) of the user 400 will hereinafter be described. For example, among the plurality of areas (221, 222, and 223) of the display 220, the first area 221 may configure a surface (or curved surface) that faces relatively upward (e.g., in a direction in which the back of the hand faces). For example, among the plurality of areas (221, 222, and 223) of the display 220, the second area 222 may configure a surface (or curved surface) that faces relatively inward (e.g., in a direction toward the body of the user 400). For example, among the plurality of areas (221, 222, and 223) of the display 220, the third area 223 may configure a surface (or curved surface) that faces relatively downward (e.g., in a direction in which the palm faces). For example, the strap 210 of the electronic device 200 may configure a surface (or curved surface) that faces relatively outward (e.g., in the opposite direction of the body of the user 400). However, as described below in FIG. 18B, the user 400 may also attach the electronic device 200 to a body part 410 of the user 400 such that the strap 210 of the electronic device 200 configures a surface (or curved surface) that faces relatively downward (e.g., in a direction in which the palm faces).

According to an embodiment, the electronic device 200 (e.g., the processor 120) may display a screen in at least one area among the plurality of areas (e.g., 221, 222, and 223) of the display 220. For example, the electronic device 200 may display a screen in only one area among the plurality of areas (e.g., 221, 222, and 223) of the display 220 and may not display (or deactivate) a screen in the remaining areas. For example, the electronic device 200 may display a screen across two areas among the plurality of areas (e.g., 221, 222, and 223) of the display 220 and may not display (or deactivate) a screen in the remaining areas. For example, the electronic device 200 may display one screen across the plurality of areas (e.g., 221, 222, and 223) of the display 220. For example, the electronic device 200 may display a plurality of screens respectively corresponding to the plurality of areas (e.g., 221, 222, and 223) of the display 220. For example, the electronic device 200 may display one screen across two areas among the plurality of areas (e.g., 221, 222, and 223) of the display 220 and display another screen in the remaining areas.

Referring to FIG. 5, the display direction of the screen of the display 220 will hereinafter be described. The screen of the display 220 may be displayed in a first direction 591 (e.g., in the longitudinal direction of the electronic device 200) or a second direction 592 (e.g., in the width direction of the electronic device 200). Here, the display direction may refer to a viewing orientation of an image rendered on the display 220. According to an embodiment, the electronic device 200 (e.g., the processor 120) may display the screen in the first direction 591 or the second direction 592 in the first area 221 among the plurality of areas (e.g., 221, 222, and 223) of the display 220. According to an embodiment, the electronic device 200 (e.g., the processor 120) may display the screen in the first direction 591 or the second direction 592 in the second area 222 among the plurality of areas (e.g., 222, 222, and 223) of the display 220. According to an embodiment, the electronic device 200 (e.g., the processor 120) may display the screen in the first direction 591 or the second direction 592 in the third area 223 among the plurality of areas (e.g., 222, 223, and 223) of the display 220. Although FIG. 5 illustrates only the first direction 591 (e.g., the longitudinal direction of the electronic device 200) or the second direction 592 (e.g., the width direction of the electronic device 200), this is merely an example, and the electronic device 200 (e.g., the processor 120) may also display a screen in a third direction (e.g., a direction not perpendicular to the first direction 591 or the second direction 592) on at least a portion of the display 220.

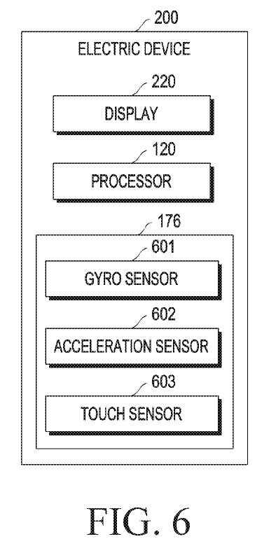

FIG. 6 is a block diagram illustrating an electronic device according to an embodiment.

Referring to FIG. 6, according to an embodiment, the electronic device 200 may include a display 220, a processor 120, and a sensor (e.g., 176 of FIG. 1). For example, the sensor (e.g., 176 of FIG. 1) may include a sensor (e.g., a gyro sensor 601) configured to detect rotation of the electronic device 200. For example, the sensor (e.g., 176 of FIG. 1) may include a sensor (e.g., an acceleration sensor 602) configured to detect movement (e.g., acceleration) of the electronic device 200. For example, the sensor (e.g., 176 of FIG. 1) may include a sensor (e.g., a touch sensor 603) configured to detect a touch on the electronic device 200. The types of sensors in FIG. 6 are merely examples. The electronic device 200 (e.g., the processor 120) may use one sensor (e.g., the gyro sensor 601) or a plurality of sensors (e.g., the gyro sensor 601 and the acceleration sensor 602) to detect rotation of the electronic device 200. The electronic device 200 (e.g., the processor 120) may use one sensor (e.g., the acceleration sensor 602) or a plurality of sensors (e.g., the gyro sensor 601 and the acceleration sensor 602) to detect movement of the electronic device 200.

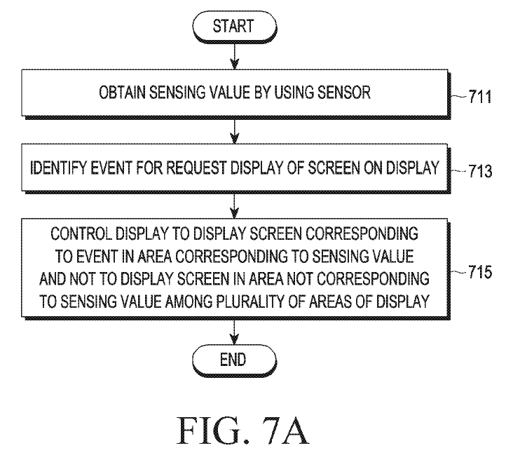

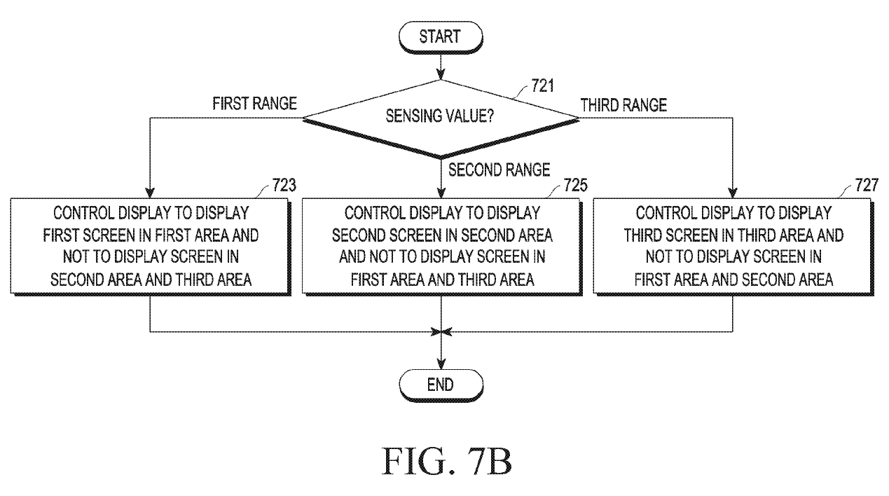

FIG. 7A is a flowchart illustrating an operating method of an electronic device according to an embodiment. FIG. 7B is a flowchart illustrating an operating method of an electronic device according to an embodiment. FIGS. 7A and 7B will be described with reference to the previously described embodiments and the embodiments described below.

In embodiments, at least some of the operations of FIG. 7A may be omitted. In embodiments, the order of the operations of FIG. 7A may be changed. In embodiments, at least two of the operations of FIG. 7A may be performed in parallel. In embodiments, operations other than the operations of FIG. 7A may be performed before, during, or after the operations of FIG. 7A.

Referring to FIG. 7A, in operation 711, according to an embodiment, the electronic device 200 (e.g., the processor 120) may obtain (or identify) a sensing value by using the sensor 176 (e.g., the gyro sensor 601 and/or the acceleration sensor 602). The electronic device 200 may identify (or sense or detect) rotation and/or movement (e.g., acceleration) of the electronic device 200 based on the sensing value (e.g., the sensing value obtained by the gyro sensor 601 and/or the sensing value obtained by the acceleration sensor 602) obtained by using the sensor 176 (e.g., the gyro sensor 601 and/or the acceleration sensor 602). According to an embodiment, the electronic device 200 may identify information about the state of the electronic device 200 based on the sensing value obtained using the sensor 176. The information about the state of the electronic device 200 may include information about whether the electronic device 200 is rotating, the rotation direction, whether it is accelerating, the acceleration direction, and/or the direction in which the electronic device 200 is facing. The information about the direction in which the electronic device 200 is facing may include information about a direction in which the display 220 (e.g., the first area 221, the second area 222, or the third area 223) or the strap 210 is facing. For example, the electronic device 200 may store, in the memory 130, information (e.g., a lookup table) in which the sensing value of the sensor 176 and the information about the state of the electronic device 200 are matched. For example, the electronic device 200 may include the memory 130 storing information (e.g., a lookup table) in which the sensing value of the sensor 176 and the information about the state of the electronic device 200 are matched. For example, the electronic device 200 may identify the sensing value of the sensor 176 and the information about the state of the electronic device 200 and store, in the memory 130, information (e.g., a lookup table) in which the sensing value of the sensor 176 and the information about the state of the electronic device 200 are matched. For example, the electronic device 200 may identify (and/or store) different information (e.g., matched information (e.g., a lookup table)) depending on the user. For example, the electronic device 200 may identify the user of the electronic device 200 and identify information (e.g., matched information (e.g., a lookup table)) corresponding to the identified user. For example, the electronic device 200 may determine that the state of the electronic device 200 corresponds to a specific state (e.g., a first state, a second state, or a third state) based on the sensing value of the sensor 176 included in a specific range (e.g., a first range, a second range, or a third range). According to an embodiment, the electronic device 200 may determine an area (e.g., at least one area among the plurality of areas 221, 222, and 223 of the display 220) corresponding to the sensing value (e.g., a sensing range including the sensing value) based on the sensing value obtained using the sensor 176. The area corresponding to the sensing value may be at least one area selected based on the obtained sensing value among the plurality of areas 221, 222, and 223 of the display 220. For example, the electronic device 200 may store, in the memory 130, information (e.g., a lookup table) in which a sensing value of the sensor 176 is matched with an area (e.g., at least one area among the plurality of areas 221, 222, and 223 of the display 220) corresponding to the sensing value. For example, the electronic device 200 may identify a specific area (e.g., at least one area among the plurality of areas 221, 222, and 223 of the display 220) corresponding to the sensing value based on whether the sensing value of the sensor 176 is included in a specific range (e.g., a first range, a second range, or a third range). The specific range, the specific area, and the specific state will be described in detail layer with reference to FIG. 7B.

In operation 713, according to an embodiment, the electronic device 200 (e.g., the processor 120) may identify an event requesting (or triggering) display of a screen on the display 220. The event requesting display of a screen may be an event requesting display, on the display 220, of a screen of a specific application installed in the electronic device. An application (e.g., a clock application, an exercise application, a message application, a biometric application, a battery application, a calendar application, a gallery application, a weather application, a phone application, a home screen application, a lock screen application, a map application, and/or a camera application) executed on the electronic device 200 may request display of a screen. The electronic device 200 may identify one event requesting display of a screen on the display 220. The electronic device 200 may identify a plurality of events requesting display of a screen on the display 220 simultaneously or sequentially. For example, the electronic device 200 may identify a second event while displaying a first screen in response to a first event. For example, the electronic device 200 may identify the second event after identifying the first event and before displaying the first screen in response to the first event. For example, the electronic device 200 may identify the first event and the second event simultaneously (e.g., within a specified time interval).

In operation 715, according to an embodiment, the electronic device 200 (e.g., the processor 120) may display a screen corresponding to an event (e.g., the event of operation 713) in an area (e.g., at least one of 221, 222, and 223) corresponding to a sensing value (e.g., the sensing value of operation 711) among a plurality of areas 221, 222, and 223 of the display 220. The electronic device 200 may control the display 220 so as not to display a screen in an area that does not correspond to the sensing value (e.g., the sensing value of operation 711) among the plurality of areas 221, 222, and 223 of the display 220. There may be no area that does not correspond to the sensing value (e.g., the sensing value of operation 711). In this case, a screen may be displayed on all of the plurality of areas 221, 222, and 223 of the display 220. There is no limitation on the number of areas (e.g., at least one of 221, 222, and 223) corresponding to the sensing value (e.g., the sensing value of operation 711). For example, the area corresponding to the sensing value (e.g., the sensing value of operation 711) may be one area of the plurality of areas 221, 222, and 223 of the display 220, two areas, or all of the plurality of areas 221, 222, and 223. There may be no area that corresponds to the sensing value (e.g., the sensing value of operation 711). In this case, a screen may not be displayed on all of the plurality of areas 221, 222, and 223 of the display 220.

Hereinafter, an embodiment in which an area corresponding to the sensing value (e.g., the sensing value of operation 711) is one of the plurality of areas 221, 222, and 223 of the display 220 will be described with reference to FIG. 7B.

In embodiments, at least some of the operations of FIG. 7B may be omitted. In embodiments, the order of the operations of FIG. 7B may be changed. In embodiments, at least two of the operations of FIG. 7B may be performed in parallel. In embodiments, operations other than the operations of FIG. 7B may be performed before, during, or after the operations of FIG. 7B.

Referring to FIG. 7B, in operation 721, according to an embodiment, the electronic device 200 (e.g., the processor 120) may identify a sensing value (e.g., the sensing value of 711 in FIG. 7A) obtained by using the sensor 176. The operation of identifying the sensing value may be an operation of identifying which value the sensing value is or an operation of identifying which range the sensing value is included in. In the embodiment of FIG. 7B, the “range” in which the sensing value is included is described, but same may be understood for the sensing “value”. The “range” (or “value”) may include a “rotation range” (or rotation value) associated with the sensing value obtained by the gyro sensor 601, and an “acceleration range” (or acceleration value) associated with the sensing value obtained by the acceleration sensor 602. For example, a sensing value included in a specific range (e.g., a first range, a second range, or a third range) may mean (1) that the sensing value obtained by the gyro sensor 601 is included in a specific rotation range, (2) that the sensing value obtained by the acceleration sensor 602 is included in a specific acceleration range, or (3) that the sensing value obtained by the gyro sensor 601 is included in a specific rotation range and the sensing value obtained by the acceleration sensor 602 is included in a specific acceleration range.

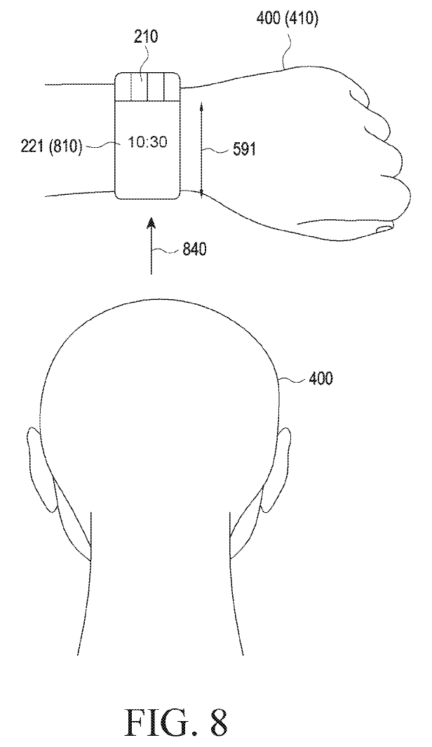

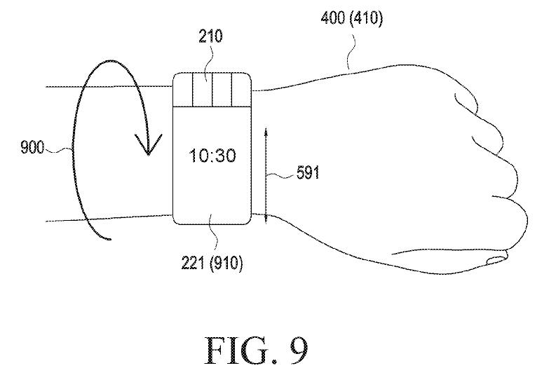

In operation 723, according to an embodiment, the electronic device 200 (e.g., the processor 120) may determine that the sensing value (e.g., the sensing value obtained by the gyro sensor 601 and/or the acceleration sensor 602) obtained by using the sensor 176 (e.g., the gyro sensor 601 and/or the acceleration sensor 602) is included in the first range (e.g., a first rotation range and/or a first acceleration range). The first range may be a range (e.g., the first rotation range, or the first acceleration range, or the first rotation range and the first acceleration range) designated corresponding to the first area 221 among the plurality of areas 221, 222, and 223 of the display 220. For example, the electronic device 200 may determine that a sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) is included in the first range based on the sensing value obtained by the gyro sensor 601 included in the first rotation range included in the first range, or the sensing value obtained by the acceleration sensor 602 included in the first acceleration range included in the first range, or the sensing value obtained by the gyro sensor 601 included in the first rotation range included in the first range and the sensing value obtained by the acceleration sensor 602 included in the first acceleration range included in the first range. The electronic device 200 (e.g., the processor 120) may control the display 220 to display a screen in the first area 221 among the plurality of areas 221, 222, and 223 of the display 220 and not to display the screen in the second area and the third area among the plurality of areas 221, 222, and 223, based on the sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) being included in the first range (e.g., the first rotation range and/or the first acceleration range). Operation 723 will be described below in greater detail with reference to FIGS. 8 and 9.

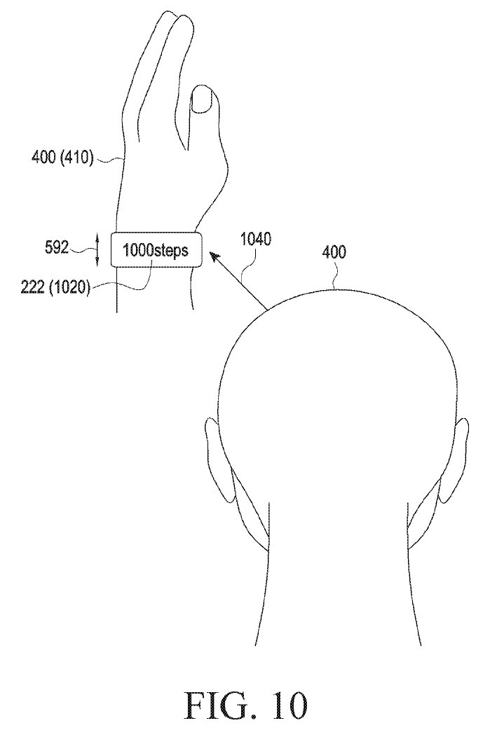

In operation 725, according to an embodiment, the electronic device 200 (e.g., the processor 120) may determine that the sensing value (e.g., the sensing value obtained by the gyro sensor 601 and/or the acceleration sensor 602) obtained by using the sensor 176 (e.g., the gyro sensor 601 and/or the acceleration sensor 602) is included in the second range (e.g., a second rotation range and/or a second acceleration range). The second range may be a range (e.g., the second rotation range, or the second acceleration range, or the second rotation range and the second acceleration range) designated corresponding to the second area 222 among the plurality of areas 221, 222, and 223 of the display 220. For example, the electronic device 200 may determine that a sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) is included in the second range based on the sensing value obtained by the gyro sensor 601 included in the second rotation range included in the second range, or the sensing value obtained by the acceleration sensor 602 included in the second acceleration range included in the second range, or the sensing value obtained by the gyro sensor 601 included in the second rotation range included in the second range and the sensing value obtained by the acceleration sensor 602 included in the second acceleration range included in the second range. The electronic device 200 (e.g., the processor 120) may control the display 220 to display a screen in the second area 222 among the plurality of areas 221, 222, and 223 of the display 220 and not to display the screen in the first area and the third area among the plurality of areas 221, 222, and 223, based on the sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) included in the second range (e.g., the second rotation range and/or the second acceleration range). Operation 725 will be described below in greater detail with reference to FIGS. 10, 11, 12, and 13.

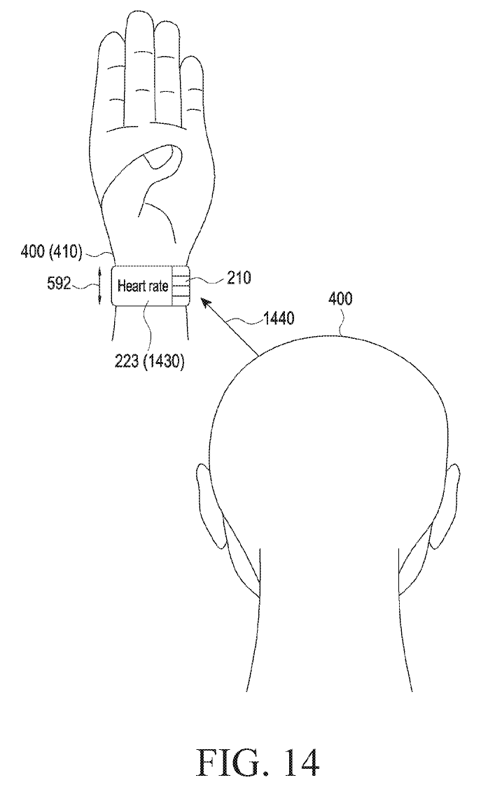

In operation 727, according to an embodiment, the electronic device 200 (e.g., the processor 120) may determine that the sensing value (e.g., the sensing value obtained by the gyro sensor 601 and/or the acceleration sensor 602) obtained by using the sensor 176 (e.g., the gyro sensor 601 and/or the acceleration sensor 602) is included in the third range (e.g., the third rotation range and/or the third acceleration range). The third range may be a range (e.g., the third rotation range, or the third acceleration range, or the third rotation range and the third acceleration range) designated corresponding to the third area 223 among the plurality of areas 221, 222, and 223 of the display 220. For example, the electronic device 200 may determine that a sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) is included in the third range based on the sensing value obtained by the gyro sensor 601 included in the third rotation range included in the third range, or the sensing value obtained by the acceleration sensor 602 included in the third acceleration range included in the third range, or the sensing value obtained by the gyro sensor 601 included in the third rotation range included in the third range and the sensing value obtained by the acceleration sensor 602 included in the third acceleration range included in the third range. The electronic device 200 (e.g., the processor 120) may control the display 220 to display a screen in the third area 223 among the plurality of areas 221, 222, and 223 of the display 220 and not to display the screen in the first area and the second area among the plurality of areas 221, 222, and 223, based on the sensing value (e.g., the sensing value obtained by the gyro sensor 601 and/or the sensing value obtained by the acceleration sensor 602) obtained using the sensor 176 (e.g., the gyro sensor 601 and/or the acceleration sensor 602) included in the third range (e.g., the third rotation range and/or the third acceleration range). Operation 727 will be described below in greater detail with reference to FIGS. 14, 15, and 16.

FIG. 8 is a diagram illustrating a screen of a first area of a display according to an embodiment. FIG. 9 is a diagram illustrating a screen of a first area of a display according to an embodiment.

FIG. 8 illustrates an embodiment in a state in which the user 400 turns the back of his or her hand while wearing the electronic device 200 and looks at the first area 221 of the display 220 of the electronic device 200. Here, a gaze direction 840 of the user 400 may be directed toward the first area 221 of the display 220 (e.g., a screen 810 of the first area 221).

Referring to FIG. 9, according to an embodiment, as the electronic device 200 rotates 900, the electronic device 200 (e.g., the processor 120) may determine that a sensing value obtained by using the sensor 176 is included in the first range corresponding to the first area 221 of the display 220. For example, the electronic device 200 may detect the rotation (e.g., 900) of the electronic device 200 by using the gyro sensor 601. The electronic device 200 may determine that the sensing value of the gyro sensor 601 related to the rotation (e.g., 900) of the electronic device 200 is included in the first rotation range that is included in the first range corresponding to the first area 221. The electronic device 200 may display a screen 910 on the first area 221 of the display 220, based on the sensing value of the gyro sensor 601 included in the first rotation range. The electronic device 200 may display the screen 910 in a first direction 591 on the first area 221 of the display 220, based on the sensing value of the gyro sensor 601 included in the first rotation range. The first direction 591 may be a useful direction for the user 400 to look at the screen 910 when the user 400 looks at the first area 221 of the display 220 of the electronic device 200 by turning the back of the hand while wearing the electronic device 200, as shown in FIG. 8. The electronic device 200 may not display (or deactivate) a screen on the second area 222 and the third area 223 of the display 220, based on the sensing value of the gyro sensor 601 included in the first rotation range. The electronic device 200 may display a screen corresponding to a first event on the first area 221 of the display 220 based on the first event (e.g., a screen display request of a time application). The electronic device 200 may display a screen corresponding to the first event on the first area 221 of the display 220 based on the sensing value of the gyro sensor 601 being included in the first rotation range and the first event being identified. For example, the electronic device 200 may display a screen (e.g., 910) (e.g., a screen including time information) according to a request of a watch application on the first area 221 of the display 220. For example, the electronic device 200 may use the first area 221 of the display 220 to display a screen similar to a screen of a smart watch implemented in the shape of a general watch. The screen displayed on the first area 221 of the display 220 is not limited to a screen similar to a screen of a general smart watch. In the embodiment of FIG. 9, the electronic device 200 may also identify that the sensing value obtained by the acceleration sensor 602 is included in the first acceleration range included in the first range corresponding to the first area 221. For example, the electronic device 200 may only identify that the sensing value of the gyro sensor 601 is included in the first rotation range, or may identify that the sensing value of the gyro sensor 601 is included in the first rotation range and the sensing value obtained by the acceleration sensor 602 is included in the first acceleration range. For example, the electronic device 200 may display a screen on the first area 221 of the display 220 only when the first rotation range is satisfied, or may display a screen on the first area 221 of the display 220 when both the first rotation range and the first acceleration range are satisfied.

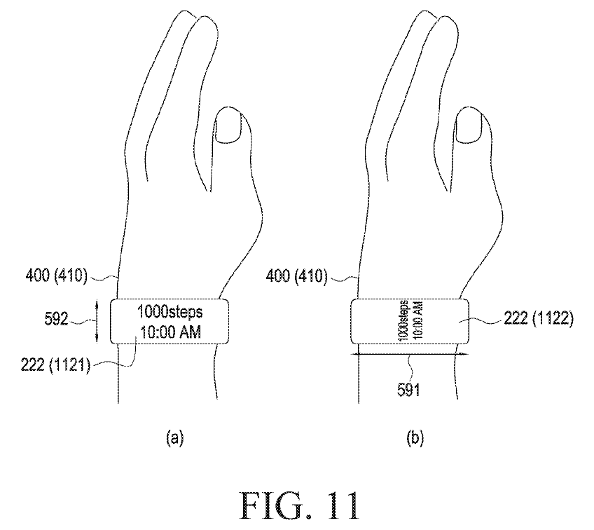

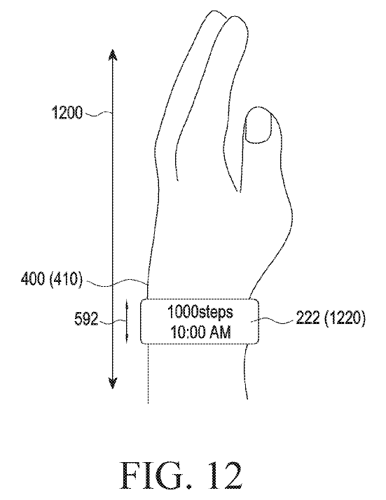

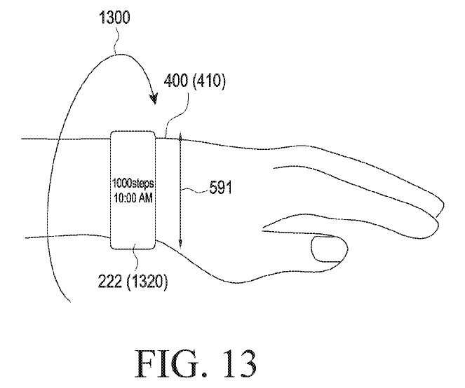

FIG. 10 is a diagram illustrating a screen of a second area of a display according to an embodiment. FIG. 11 is a diagram illustrating a screen of a second area of a display according to an embodiment. FIG. 12 is a diagram illustrating a screen of a second area of a display according to an embodiment. FIG. 13 is a diagram illustrating a screen of a second area of a display of an electronic device according to an embodiment.

FIG. 10 illustrates an embodiment in a state in which the user 400 looks at the second area 222 of the display 220 of the electronic device 200 without turning the wrist (e.g., while walking or running) while wearing the electronic device 200. Here, a gaze direction 1040 of the user 400 may be directed toward the second area 222 of the display 220 (e.g., a screen 1020 of the second area 222).

Referring to FIG. 11, according to an embodiment, the electronic device 200 (e.g., the processor 120) may display a screen 1121 in a second direction 592 on the second area 222 of the display 220, as in part (a) of FIG. 11, or may display a screen 1122 in a first direction 591 on the second area 222 of the display 220, as in part (b) of FIG. 11. An embodiment of displaying a screen on the second area 222 in the second direction 592 will be described later with reference to FIG. 12. An embodiment of displaying a screen on the second area 222 in the second direction 591 will be described later with reference to FIG. 13.

Referring to FIG. 12, according to an embodiment, when the electronic device 200 moves in a specific direction 1200, the electronic device 200 (e.g., the processor 120) may determine that a sensing value obtained by using the sensor 176 is included in the second range corresponding to the second area 222 of the display 220. For example, the electronic device 200 may detect the movement (e.g., 1200) of the electronic device 200 by using the acceleration sensor 602. The electronic device 200 may determine that the sensing value of the acceleration sensor 602 related to the movement (e.g., 1200) of the electronic device 200 is included in the second acceleration range that is included in the second range corresponding to the second area 222. The electronic device 200 may display a screen 1220 on the second area 222 of the display 220, based on the sensing value of the acceleration sensor 602 included in the second acceleration range. The electronic device 200 may display a screen 1220 in the second direction 592 on the second area 222 of the display 220, based on the sensing value of the acceleration sensor 602 included in the second acceleration range. The second direction 592 may be a useful direction for the user 400 to look at the screen 1020 or 1220 when the user 400 looks at the second area 222 of the display 220 of the electronic device 200 without turning the wrist (e.g., while walking or running) while wearing the electronic device 200, as shown in FIG. 10 or FIG. 12. The electronic device 200 may not display (or deactivate) a screen on the first area 221 and the third area 223 of the display 220, based on the sensing value of the acceleration sensor 602 included in the second acceleration range. The electronic device 200 may display a screen corresponding to a second event on the second area 222 of the display 220 based on the second event (e.g., a screen display request of an exercise application). The electronic device 200 may display a screen corresponding to the second event on the second area 222 of the display 220 based on the sensing value of the acceleration sensor 602 being included in the second acceleration range and the second event being identified. For example, the electronic device 200 may display a screen (e.g., 1220) (e.g., a screen including exercise information) according to a request of an exercise application on the second area 222 of the display 220. For example, the electronic device 200 may use the second area 222 of the display 220 to display a screen including information (e.g., number of steps, exercise time, or exercise type) related to an exercise being performed by the user 400. According to an embodiment, if it is determined that there is no movement of the electronic device 200 based on the sensing value by the sensor 176, for example, if it is determined that the user 400 has stopped exercising, the electronic device 200 may stop displaying a screen displayed on the second area 222 of the display 220. The screen displayed on the second area 222 of the display 220 is not limited to a screen including information (e.g., number of steps, exercise time, or exercise type) related to the exercise being performed by the user 400. In the embodiment of FIG. 12, the electronic device 200 may also identify that the sensing value obtained by the gyro sensor 601 is included in the second rotation range included in the second range corresponding to the second area 222. For example, the electronic device 200 may only identify that the sensing value of the acceleration sensor 602 is included in the second acceleration range, or may identify that the sensing value of the acceleration sensor 602 is included in the second acceleration range and the sensing value obtained by the gyro sensor 601 is included in the second rotation range. For example, the electronic device 200 may display a screen on the second area 222 of the display 220 only when the second acceleration range is satisfied, or may display a screen on the second area 222 of the display 220 when both the second acceleration range and the second rotation range are satisfied.

Referring to FIG. 13, according to an embodiment, as the electronic device 200 rotates 1300, the electronic device 200 (e.g., the processor 120) may determine that a sensing value obtained by using the sensor 176 is included in the second range corresponding to the second area 222 of the display 220. For example, the electronic device 200 may detect the rotation (e.g., 1300) of the electronic device 200 by using the gyro sensor 601. The electronic device 200 may determine that the sensing value of the gyro sensor 601 related to the rotation (e.g., 1300) of the electronic device 200 is included in the second rotation range that is included in the second range corresponding to the second area 222. The electronic device 200 may display a screen 1320 on the second area 222 of the display 220, based on the sensing value of the gyro sensor 601 included in the second rotation range. The electronic device 200 may display the screen 1320 in the first direction 591 on the second area 222 of the display 220, based on the sensing value of the gyro sensor 601 included in the second rotation range. The first direction 591 may be a useful direction for the user 400 to look at the screen 1320 when the user 400 looks at the second area 222 of the display 220 of the electronic device 200 by turning the back of the hand while wearing the electronic device 200. The electronic device 200 may not display (or deactivate) a screen on the first area 221 and the third area 223 of the display 220, based on the sensing value of the gyro sensor 601 included in the second rotation range. The electronic device 200 may display a screen corresponding to a second event on the second area 222 of the display 220 based on the second event (e.g., a screen display request of an exercise application). The electronic device 200 may display a screen corresponding to the second event on the second area 222 of the display 220 based on the sensing value of the gyro sensor 601 being included in the second rotation range and the second event being identified. For example, the electronic device 200 may display a screen (e.g., 1320) (e.g., a screen including exercise information) according to a request of an exercise application on the second area 222 of the display 220.

Referring to FIGS. 12 and 13, in the case of the second area 222 of the display 220, the user 400 may look at the second area 222 of the display 220 of the electronic device 200 without turning the wrist (e.g., while walking or running) while wearing the electronic device 200, and the user 400 may look at the second area 222 of the display 220 of the electronic device 200 by turning the back of the hand while wearing the electronic device 200, so that both the embodiments of FIG. 12 and FIG. 13 may be possible. For example, the user 400 may view the second area 222 without turning the wrist (e.g., while walking or running) as shown in FIG. 12, or by turning the back of the hand as shown in FIG. 13.

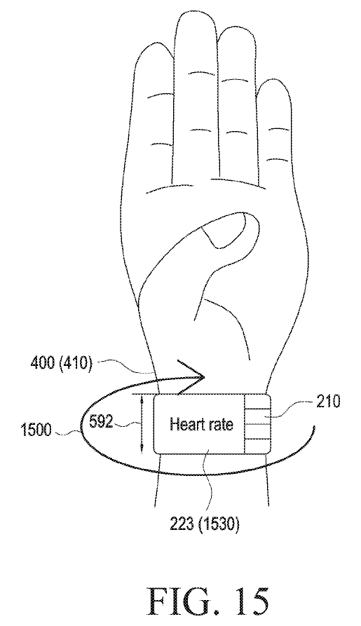

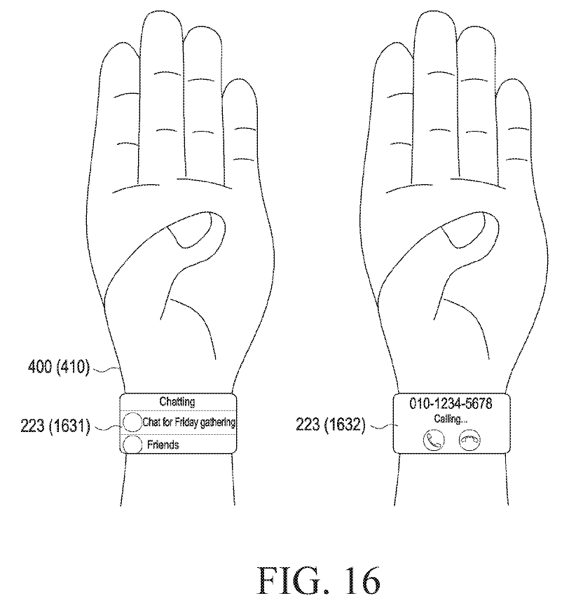

FIG. 14 is a diagram illustrating a screen of a third area of a display according to an embodiment. FIG. 15 is a diagram illustrating a screen of a third area of a display according to an embodiment. FIG. 16 is a diagram illustrating a screen of a third area of a display according to an embodiment.

FIG. 14 illustrates an embodiment in a state in which the user 400 wears the electronic device 200 and turns his/her wrist inward to look at the third area 223 of the display 220 of the electronic device 200. Here, a gaze direction 1440 of the user 400 may be directed toward the third area 223 of the display 220 (e.g., a screen 1430 of the third area 223). The third area 223 of the display 220 is generally a portion facing the body of the user 400 and may be a portion that is not easily visible to a third party.

Referring to FIG. 15, according to an embodiment, as the electronic device 200 rotates 1500, the electronic device 200 (e.g., the processor 120) may determine that a sensing value obtained by using the sensor 176 is included in the third range corresponding to the third area 223 of the display 220. For example, the electronic device 200 may detect the rotation (e.g., 1500) of the electronic device 200 by using the gyro sensor 601. The electronic device 200 may determine that the sensing value of the gyro sensor 601 related to the rotation (e.g., 1500) of the electronic device 200 is included in the third rotation range that is included in the third range corresponding to the third area 223. The electronic device 200 may display a screen 1530 on the third area 223 of the display 220, based on the sensing value of the gyro sensor 601 included in the third rotation range. The electronic device 200 may display a screen 1530 in the second direction 592 on the third area 223 of the display 220, based on the sensing value of the gyro sensor 601 included in the third rotation range. The second direction 592 may be a useful direction for the user 400 to look at the screen 1430 or 1530 when the user 400 looks at the third area 223 of the display 220 of the electronic device 200 by turning the wrist inward (e.g., while walking or running) while wearing the electronic device 200, as shown in FIG. 14 or FIG. 15. The electronic device 200 may not display (or deactivate) a screen on the first area 221 and the second area 222 of the display 220, based on the sensing value of the gyro sensor 601 included in the third rotation range. The electronic device 200 may display a screen corresponding to a third event on the third area 223 of the display 220 based on the third event (e.g., a screen display request of a biometric signal application). The electronic device 200 may display a screen corresponding to the third event on the third area 223 of the display 220 based on the sensing value of the gyro sensor 601 being included in the third rotation range and the third event being identified. For example, the electronic device 200 may display a screen (e.g., 1530) (e.g., a screen including biometric information (e.g., heart rate), or a screen of the embodiment of FIG. 16) according to the request of a biometric signal application in the third area 223 of the display 220. For example, the electronic device 200 may use the third area 223 of the display 220 to display a screen including information related to the privacy of the user 400. In the embodiment of FIG. 15, the electronic device 200 may also identify that the sensing value obtained by the acceleration sensor 602 is included in the third acceleration range included in the third range corresponding to the third area 223. For example, the electronic device 200 may only identify that the sensing value of the gyro sensor 601 is included in the third rotation range, or may identify that the sensing value of the gyro sensor 601 is included in the third rotation range and the sensing value obtained by the acceleration sensor 602 is included in the third acceleration range. For example, the electronic device 200 may display a screen on the third area 223 of the display 220 only when the third rotation range is satisfied, or may display a screen on the third area 223 of the display 220 when both the third rotation range and the third acceleration range are satisfied.

Referring to FIG. 16, according to an embodiment, the electronic device 200 (e.g., the processor 120) may display a screen of a designated application (e.g., a screen including information related to the privacy of the user 400) on the third area 223 of the display 220. For example, the electronic device 200 may display a screen of an application including a message, SNS, personal conversation content 1631, or sender or receiver information of a phone call 1632 on the third area 223 of the display 220. The screen displayed on the third area 223 of the display 220 is not limited to a screen including information related to the privacy of the user 400.

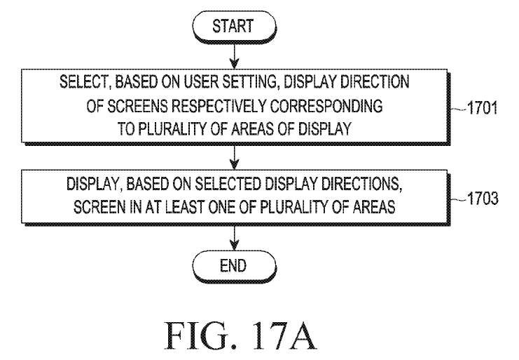

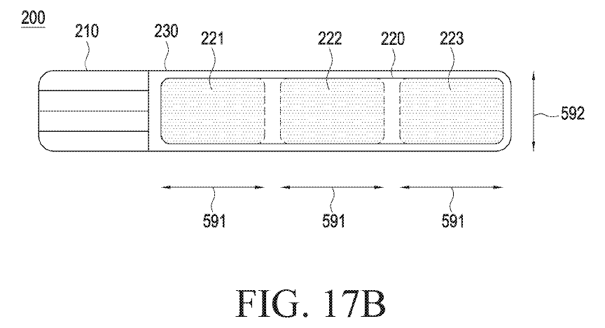

FIG. 17A is a flowchart illustrating an operating method of an electronic device according to an embodiment. FIG. 17B is a diagram illustrating a display direction of a screen of an electronic device according to an embodiment. FIGS. 17A and 17B will hereinafter be described with reference to the previously described embodiments and the embodiments described below.

In embodiments, at least some of the operations of FIG. 17A may be omitted. In embodiments, the order of the operations of FIG. 17A may be changed. In embodiments, at least two of the operations of FIG. 17A may be performed in parallel. In embodiments, operations other than the operations of FIG. 17A may be performed before, during, or after the operations of FIG. 17A.

Referring to FIG. 17A, in operation 1701, according to an embodiment, the electronic device 200 (e.g., the processor 120) may select display direction(s) of screen(s) respectively corresponding to the plurality of areas 221, 222, and 223 of the display 220 based on a user setting. For example, referring to FIG. 17B, the electronic device 101 may select a display direction (e.g., the first direction 591 or the second direction 592) of a screen to be displayed in the first area 221 among the plurality of areas 221, 222, and 223 of the display 220 based on the user setting. For example, referring to FIG. 17B, the electronic device 101 may select a display direction (e.g., the first direction 591 or the second direction 592) of a screen to be displayed in the second area 222 among the plurality of areas 221, 222, and 223 of the display 220 based on the user setting. For example, referring to FIG. 17B, the electronic device 101 may select a display direction (e.g., the first direction 591 or the second direction 592) of a screen to be displayed in the third area 223 among the plurality of areas 221, 222, and 223 of the display 220 based on the user setting.

In operation 1703, according to an embodiment, the electronic device 200 (e.g., the processor 120) may display screen(s) in the selected display direction(s) in at least one of the plurality of areas 221, 222, and 223 of the display 220 based on the selected display direction(s) (e.g., the display direction(s) selected in operation 1701).

FIG. 18A is a flowchart illustrating an operating method of an electronic device according to an embodiment. FIG. 18B is a diagram illustrating a display area of a screen of an electronic device according to an embodiment. FIG. 18C is a diagram illustrating a display area of a screen of an electronic device according to an embodiment. FIGS. 18A, 18B, and 18C, will hereinafter be described with reference to the previously described embodiments and the embodiments described below.

In embodiments, at least some of the operations of FIG. 18A may be omitted. In embodiments, the order of the operations of FIG. 18A may be changed. In embodiments, at least two of the operations of FIG. 18A may be performed in parallel. In embodiments, operations other than the operations of FIG. 18A may be performed before, during, or after the operations of FIG. 18A.

FIG. 18B illustrates an embodiment in a state in which, depending on the wearing state of the electronic device 200, the first area 221 of the display 220 configures a surface (or curved surface) that faces relatively upward (e.g., in a direction in which the back of the hand faces). In an embodiment, as shown in FIG. 18b, while the user 400 is wearing the electronic device 200, the user may turn the back of the hand to look at the first area 221 of the display 220 of the electronic device 200. Here, a gaze direction 1841 of the user 400 may be directed toward the first area 221 of the display 220 (e.g., a screen 1810 of the first area 221).

FIG. 18C illustrates an embodiment in a state in which, depending on the wearing state of the electronic device 200, the second area 222 of the display 220 configures a surface (or curved surface) that faces relatively upward (e.g., in a direction in which the back of the hand faces). In an embodiment, as shown in FIG. 18C, while the user 400 is wearing the electronic device 200, the user may turn the back of the hand to look at the second area 222 of the display 220 of the electronic device 200. Here, a gaze direction 1842 of the user 400 may be directed toward the second area 222 of the display 220 (e.g., a screen 1820 of the second area 222).

Referring to FIG. 18A, in operation 1801, according to an embodiment, the electronic device 200 (e.g., the processor 120) may identify a configuration selected by a user input. The user 400 may select a screen display configuration of the electronic device 200 through a screen displayed on the electronic device 200 or through a screen displayed on another electronic device (e.g., a mobile device) connected to the electronic device 200. The screen display configuration of the electronic device 200 may include a first setting corresponding to a state in which the electronic device 200 is worn, as in FIG. 18B, and a second configuration corresponding to a state in which the electronic device 200 is worn, as in FIG. 18C. For example, in the case of a screen including time information according to the request of a watch application, it may be desirable to display the screen in the first area 221 of the display 220 in a state such as FIG. 18B, and it may be desirable to display the screen in the second area 222 of the display 220 in a state such as FIG. 18C. In such an embodiment, since the user 400 may determine the wearing state of the electronic device 200, an appropriate screen may be displayed in an appropriate area by the user 400 selecting the screen display configuration of the electronic device 200. That is, the user 400 may be allowed to select a display configuration based on the wearing state of the electronic device 200, the electronic device 200 may display a screen in an optimal area corresponding to the selection by the user 400.

In operation 1803, according to an embodiment, the electronic device 200 (e.g., the processor 120) may display a screen (e.g., a screen 1810 including time information of FIG. 18B) corresponding to a first event (e.g., a screen display request of a clock application) on the first area 221 of the display 220 based on the selection of the first setting in operation 1801. For example, the electronic device 200 may display a screen corresponding to the first event on the first area 221 of the display 220 based on the selection of the first setting in operation 1801, when the selection of the sensing value obtained by the sensor 176 is included in the first range, and the first event is identified.

In operation 1805, according to an embodiment, the electronic device 200 (e.g., the processor 120) may display a screen (e.g., a screen 1810 including time information of FIG. 18B) corresponding to a first event (e.g., a screen display request of a clock application) on the second area 222 of the display 220 based on the selection of the second setting in operation 1801. For example, the electronic device 200 may display a screen corresponding to the first event on the second area 222 of the display 220 based on the selection of the second setting in operation 1801, when the selection of the sensing value obtained by the sensor 176 is included in the first range, and the first event is identified.

Although FIGS. 18A, 18B, and 18C are described with reference to the first area 221 and the second area 222, this is only an example. Accordingly, embodiments similar to those of FIGS. 18A, 18B, and 18C may be similarly applied to the second area 222 and the third area 223.

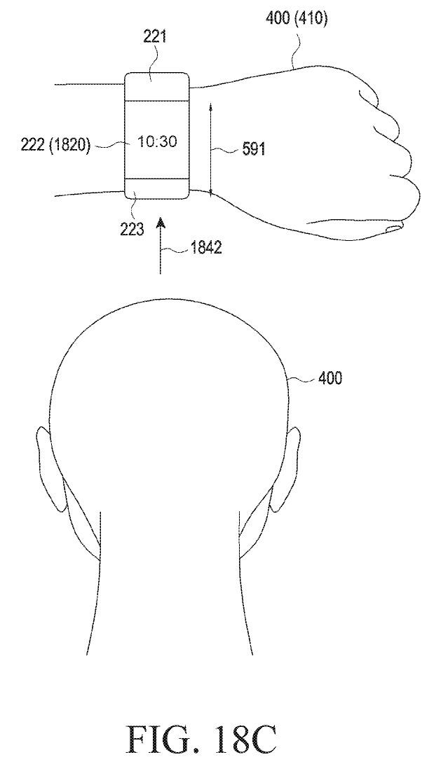

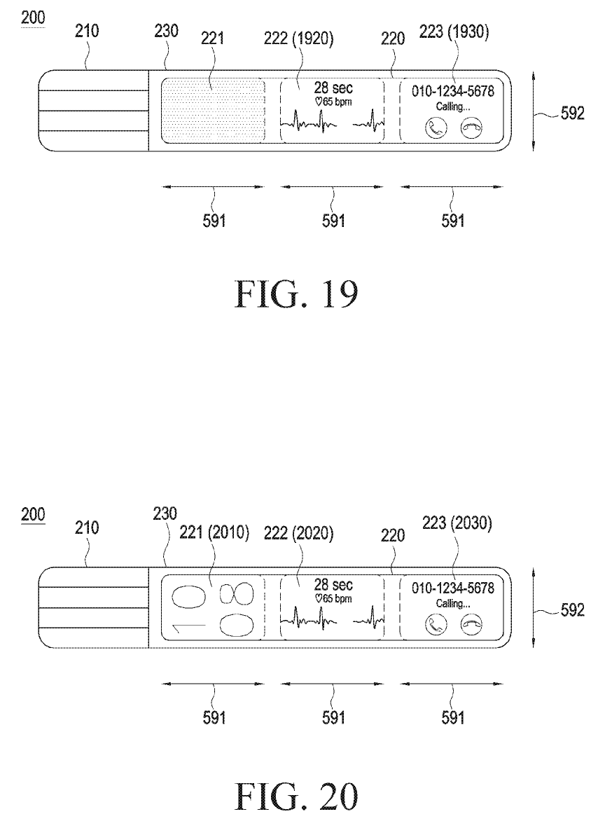

FIG. 19 is a diagram illustrating display of screens of a plurality of areas of a display according to an embodiment. FIG. 20 is a diagram illustrating display of screens of a plurality of areas of a display according to an embodiment.

As shown in FIG. 19, an embodiment of the electronic device 200 (e.g., the processor 120) may display a screen 1920 in the second area 222 of the display 220 and display a screen 1930 in the third area 223 of the display 220. For example, in case that a screen 1920 including exercise information is displayed in the second area 222 of the display 220 when the user 400 wears the electronic device 200 and performs exercise, the electronic device 200 may display a screen 1930 including privacy information in the third area 223 while displaying the screen 1920 including exercise information in the second area 222 of the display 220 based on a screen display request from an application that performs a function including privacy information (e.g., sender information or receiver information of a call) being identified.

As shown in FIG. 20, an embodiment of the electronic device 200 (e.g., the processor 120) may, according to the user setting, display a screen 2010 in the first area 221 of the display 220, display a screen 2020 in the second area 222 of the display 220, and display a screen 2030 in the third area 223 of the display 220.

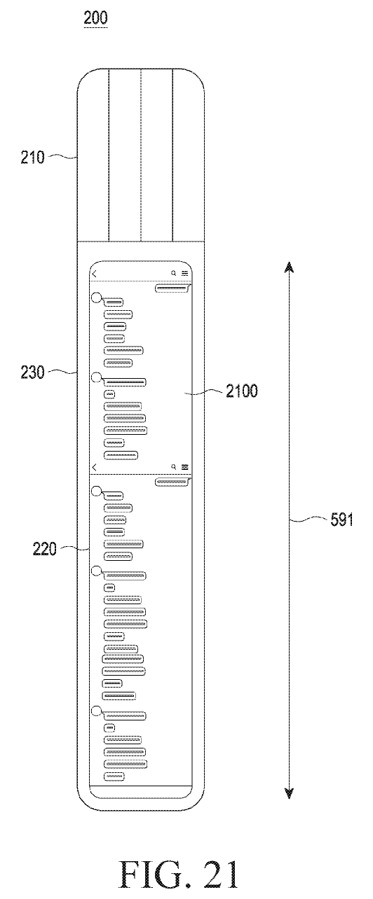

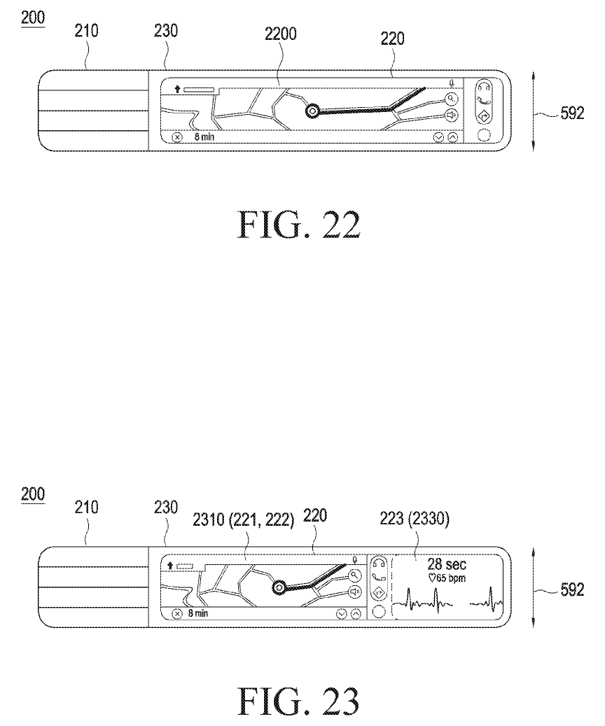

FIG. 21 is a diagram illustrating display of a screen of an electronic device according to an embodiment. FIG. 22 is a diagram illustrating display of a screen of an electronic device according to an embodiment. FIG. 23 is a diagram illustrating display of a screen of an electronic device according to an embodiment.

Referring to FIGS. 21, 22, and 23, the screen display of the designated application may be understood.

According to an embodiment, the electronic device 200 (e.g., the processor 120) may control the display 220 to display the screen of the designated application on a whole of the display 160 or 220 in a display direction corresponding to the designated application, based on the identified event corresponding to an event of displaying the screen of the designated application.

For example, referring to FIG. 21, the electronic device 200 (e.g., the processor 120) may control the display 220 to display a screen 2100 of the message application in the first direction 591 corresponding to the message application on the whole of the display 220 based on the identified event being corresponding to an event for displaying the screen of the message application. In the case of the message application with a vertically long screen, readability for a user may be improved by displaying the screen corresponding to the message application in the first direction 591.

For example, referring to FIG. 22, the electronic device 200 (e.g., the processor 120) may control the display 220 to display a screen 2200 of the map application in the second direction 592 corresponding to the map application on the whole of display 220 based on the identified event being corresponding to an event for displaying the screen of the map application. In the case of the map application with a horizontally long screen, readability for a user may be improved by displaying the screen corresponding to the map application in the second direction 592.

Referring to FIG. 23, according to an embodiment, the electronic device 200 (e.g., the processor 120) may display the screen (2200) of the map application across the first area 221 and the second area 222 of the display 220 according to the user setting, based on the identified event being corresponding to an event for displaying the screen of the map application. In this case, a screen 2330 of another application may be displayed on the third area 223 of the display 220.

Those skilled in the art will understand that the embodiments described herein may be applied in combination with one another within the scope of applicability. For example, those skilled in the art will understand that at least some operations of the embodiments described herein may be omitted and applied, and that at least some operations of the embodiments may be applied in combination.

The technical problems solved by the disclosure are not limited to the above technical problems and those skilled in the art will more clearly understand other technical problems from the following description.

It will be appreciated by a person skilled in the art that effects which may be achieved from the disclosure are not limited to the effects described above and other effects that are not described above will be clearly understood from the following detailed description.

According to an embodiment, an electronic device 101 or 200 may include a housing 230, a flexible display 160 or 220 disposed on the housing 230, a strap 210 connected to the housing 230 and configured to attach the electronic device 101 or 200 to a wrist of a user, a first sensor 176 or 601 configured to detect or identify a rotation of the electronic device 101 or 200, when the electronic device 101 or 200 rotates based on a rotation of the wrist of the user, a second sensor 176 or 602 configured to detect or identify a movement of the electronic device 101 or 200, when the electronic device 101 or 200 moves based on a movement of an arm of the suer, a processor 120, and memory 130 storing instructions. The instructions may be configured to, when executed by the processor 120, cause the electronic device 101 or 200 to obtain a sensing value using the first sensor 176 or 601 or the second sensor 176 or 602, in a state where the electronic device 101 or 200 is attached to the wrist of the suer by the strap 210. The instructions may be configured to, when executed by the processor 120, cause the electronic device 101 or 200 to identify an event for requesting display of a screen on the display 160 or 220. The instructions may be configured to, when executed by the processor 120, cause the electronic device 101 or 200 to control the display 160 or 220 to display, based on the sensing value, a screen corresponding to the event in an area corresponding to the sensing value among a plurality of areas of the display 160 or 220.

According to an embodiment, the instructions may be configured to, when executed by the processor 120, cause the electronic device 101 or 200 to control the display 160 or 220 not to display a screen in an area not corresponding to the sensing value among the plurality of areas of the display 160 or 220.

According to an embodiment, the display 160 or 220 may include a first area 221 which displays a screen in a first display direction and at least one area 222 or 223 in which a display direction of a screen may be changed to a second display direction different from the first display direction.

According to an embodiment, the instructions may be configured to, when executed by the processor 120, cause the electronic device 101 or 200 to, based on the sensing value being included in a first range, control the display 160 or 220 to display a first screen in a first area 221 among the plurality of areas, and not to display a screen in a second area 222 and a third area 223 among the plurality of areas. According to an embodiment, the instructions may be configured to, when executed by the processor 120, cause the electronic device 101 or 200 to, based on the sensing value being included in a second range, control the display 160 or 220 to display a second screen in the second area 222, and not to display a screen in the first area 221 and the third area 223. According to an embodiment, the instructions may be configured to, when executed by the processor 120, cause the electronic device 101 or 200 to, based on the sensing value being included in a third range, control the display 160 or 220 to display a third screen in the third area 223 and not to display a screen in the first area 221 and the second area 222.

According to an embodiment, the instructions may be configured to, when executed by the processor 120, cause the electronic device 101 or 200 to, based on the sensing value being included in the first range, control the display 160 or 220 to display the first screen in the first area 221 in a first direction. According to an embodiment, the instructions may be configured to, when executed by the processor 120, cause the electronic device 101 or 200 to, based on the sensing value being included in the second range, control the display 160 or 220 to display the first screen in the second area 222 in a second direction different from the first direction. According to an embodiment, the instructions may be configured to, when executed by the processor 120, cause the electronic device 101 or 200 to, based on the sensing value being included in the third range, control the display 160 or 220 to display the third screen in the third area 223 in the second direction.

According to an embodiment, the first sensor 176 or 601 may include a gyro sensor 176 or 601. The instructions may be configured to, when executed by the processor 120, cause the electronic device 101 or 200 to detect or identify a rotation of the electronic device 101 or 200 using the gyro sensor 176 or 601. The instructions may be configured to, when executed by the processor 120, cause the electronic device 101 or 200 to, based on a sensing value of the gyro sensor 176 or 601 related to the rotation being included in a first rotation range, control the display 160 or 220 to display the first screen corresponding to a first event in the first area 221 in the first direction.

According to an embodiment, the second sensor 176 or 602 may include an acceleration sensor 176 or 602. The instructions may be configured to, when executed by the processor 120, cause the electronic device 101 or 200 to detect or identify a movement of the electronic device 101 or 200 using the acceleration sensor 176 or 602. The instructions may be configured to, when executed by the processor 120, cause the electronic device 101 or 200 to, based on a sensing value of the acceleration sensor 176 or 602 related to the movement being included in a first acceleration range, control the display 160 or 220 to display the second screen corresponding to a second event in the second area 222 in the second direction.

According to an embodiment, the instructions may be configured to, when executed by the processor 120, cause the electronic device 101 or 200 to, based on a sensing value of the gyro sensor 176 or 601 related to the rotation being included in a second rotation range, control the display 160 or 220 to display the third screen corresponding to a third event in the third area 223 in the second direction.

According to an embodiment, the instructions may be configured to, when executed by the processor 120, cause the electronic device 101 or 200 to, based on a user setting, select display directions of screens respectively corresponding to the plurality of areas of the display 160 or 220. According to an embodiment, the instructions may be configured to, when executed by the processor 120, cause the electronic device 101 or 200 to, based on the selected display directions, control the display 160 or 220 to display a screen in at least one area among the plurality of areas.

According to an embodiment, the instructions may be configured to, when executed by the processor 120, cause the electronic device 101 or 200 to, based on a first setting being selected by a user input, control the display 160 or 220 to display the screen corresponding to the first event in the first area 221. The instructions may be configured to, when executed by the processor 120, cause the electronic device 101 or 200 to, based on a second setting being selected by a user input, control the display 160 or 220 to display the screen corresponding to the first event in the second area 222.

According to an embodiment, the instructions may be configured to, when executed by the processor 120, cause the electronic device 101 or 200 to, based on the event being identified as an event for displaying a screen of a designated application, control the display 160 or 220 to display the screen of the designated application on a whole of the display 160 or 220 in a display direction corresponding to the designated application.

According to an embodiment, the instructions may be configured to, when executed by the processor 120, cause the electronic device 101 or 200 to, based on the event being identified as an event for displaying a screen of a message application, control the display 160 or 220 to display the screen of the message application on the whole of the display 160 or 220 in a first display direction corresponding to the message application. The instructions may be configured to, when executed by the processor 120, cause the electronic device 101 or 200 to, based on the event being identified as an event for displaying a screen of a map application, control the display 160 or 220 to display the screen of the map application on the whole of the display 160 or 220 in a second display direction corresponding to the map application.

According to an embodiment, an operating method of an electronic device 101 or 200 may include an operation of obtaining a sensing value by using a first sensor 176 or 601 or a second sensor 176 or 602 of the electronic device 101 or 200 while the electronic device 101 or 200 is worn on a wrist of a user by a strap 210 of the electronic device 101 or 200. The first sensor 176 or 601 may correspond to a sensor configured to detect or identify a rotation of the electronic device 101 or 200, when the electronic device 101 or 200 rotates based on a rotation of the wrist of the suer. The second sensor 176 or 602 may correspond to a sensor configured to detect or identify a movement of the electronic device 101 or 200, when the electronic device 101 or 200 moves based on a movement of an arm of the user. The method may include an operation of identifying an event requesting display of a screen on a display 160 or 220 of the electronic device 101 or 200. The method may include an operation of controlling the display 160 or 220 to display a screen corresponding to the event in an area corresponding to the sensing value among a plurality of areas of the display 160 or 220, based on the sensing value.

According to an embodiment, the method may include an operation of controlling the display 160 or 220 not to display a screen in an area not corresponding to the sensing value among the plurality of areas of the display 160 or 220.

According to an embodiment, the operation of controlling the display 160 or 220 may include an operation of controlling the display 160 or 220 to display a screen in a second display direction which is different from a first display direction in which the screen is displayed in a first area 221 of the display 160 or 220, in at least one area 222 or 223 of the display 160 or 220.

According to an embodiment, the operation of controlling the display 160 or 220 may include an operation of, based on the sensing value being included in a first range, controlling the display 160 or 220 to display a first screen in the first area 221 among the plurality of areas, and not to display a screen in a second area 222 and a third area 223 among the plurality of areas. The operation of controlling the display 160 or 220 may include an operation of, based on the sensing value being included in a second range, controlling the display 160 or 220 to display a second screen in the second area 222, and not to display a screen in the first area 221 and the third area 223. The operation of controlling the display 160 or 220 may include an operation of, based on the sensing value being included in a third range, controlling the display 160 or 220 to display a third screen in the third area 223, and not to display a screen in the first area 221 and the second area 222.

According to an embodiment, the operation of controlling the display 160 or 220 may include an operation of, based on the sensing value being included in the first range, controlling the display 160 or 220 to display the first screen in the first area 221 in a first direction. The operation of controlling the display 160 or 220 may include an operation of, based on the sensing value being included in the second range, controlling the display 160 or 220 to display the second screen in the second area 222 in a second direction different from the first direction. The operation of controlling the display 160 or 220 may include an operation of, based on the sensing value being included in the third range, controlling the display 160 or 220 to display the third screen in the third area 223 in the second direction.

According to an embodiment, the first sensor 176 or 601 may include a gyro sensor 176 or 601. The method may include an operation of detecting or identifying a rotation of the electronic device 101 or 200 by using the gyro sensor 176 or 601. The operation of controlling the display 160 or 220 may include an operation of, based on a sensing value of the gyro sensor 176 or 601 related to the rotation being included in a first rotation range, controlling the display 160 or 220 to display the first screen corresponding to a first event in the first area 221 in the first direction.

According to an embodiment, the second sensor 176 or 602 may include an acceleration sensor 176 or 602. The method may include an operation of detecting or identifying a movement of the electronic device 101 or 200 by using the acceleration sensor 176 or 602. The operation of controlling the display 160 or 220 may include an operation of, based on a sensing value of the acceleration sensor 176 or 602 related to the acceleration being included in a first acceleration range, controlling the display 160 or 220 to display the second screen corresponding to a second event in the second area 222 in the second direction.

According to an embodiment, the operation of controlling the display 160 or 220 may include an operation of, based on a sensing value of the gyro sensor 176 or 601 related to the rotation being included in a second rotation range, controlling the display 160 or 220 to display the third screen corresponding to a third event in the third area 223 in the second direction.

According to an embodiment, the method may include an operation of, based on a user setting, selecting display directions of screens respectively corresponding to the plurality of areas of the display 160 or 220. The operation of controlling the display 160 or 220 may include an operation of, based on the selected display directions, controlling the display 160 or 220 to display a screen in at least one area among the plurality of areas.

According to an embodiment, the operation of controlling the display 160 or 220 may include an operation of, based on a first setting being selected by a user input, controlling the display 160 or 220 to display the screen corresponding to a first event in the first area 221. The operation of controlling the display 160 or 220 may include an operation of, based on a second setting being selected by a user input, controlling the display 160 or 220 to display the screen corresponding to the first event in the second area 222.

According to an embodiment, the operation of controlling the display 160 or 220 may include an operation of, based on the event being identified as an event for displaying a screen of a designated application, controlling the display 160 or 220 to display the screen of the designated application on a whole of the display 160 or 220 in a display direction corresponding to the designated application.

According to an embodiment, the operation of controlling the display 160 or 220 may include an operation of, based on the event being identified as an event for displaying a screen of a message application, controlling the display 160 or 220 to display the screen of the message application on the whole of the display 160 or 220 in a first display direction corresponding to the message application. The operation of controlling the display 160 or 220 may include an operation of, based on the event being identified as an event for displaying a screen of a map application, control the display 160 or 220 to display the screen of the map application on the whole of the display 160 or 220 in a second display direction corresponding to the map application.

According to an embodiment, provided is a computer readable recording medium storing instructions configured to cause a processor 120 of an electronic device 101 or 200 to perform at least one operation, where the at least one operation may include an operation of obtaining a sensing value by using a first sensor 176 or 601 or a second sensor 176 or 602 of the electronic device 101 or 200 while the electronic device 101 or 200 is worn on a wrist of a user by a strap 210 of the electronic device 101 or 200. The first sensor 176 or 601 may correspond to a sensor configured to detect or identify a rotation of the electronic device 101 or 200, when the electronic device 101 or 200 rotates based on a rotation of the wrist of the user. The second sensor 176 or 602 may correspond to a sensor configured to detect or identify a movement of the electronic device 101 or 200, when the electronic device 101 or 200 moves based on a movement of an arm of the user. The at least one operation may include an operation of identifying an event requesting display of a screen on a display 160 or 220 of the electronic device 101 or 200. The at least one operation may include an operation of controlling the display 160 or 220 to display a screen corresponding to the event in an area corresponding to the sensing value among a plurality of areas of the display 160 or 220, based on the sensing value.

According to an embodiment, the at least one operation may include an operation of controlling the display 160 or 220 not to display a screen in an area not corresponding to the sensing value among the plurality of areas of the display 160 or 220.

According to an embodiment, the operation of controlling the display 160 or 220 may include an operation of controlling the display 160 or 220 to display a screen in a second display direction which is different from a first display direction in which the screen is displayed in a first area 221 of the display 160 or 220, in at least one area 222 or 223 of the display 160 or 220.

According to an embodiment, the operation of controlling the display 160 or 220 may include an operation of, based on the sensing value being included in a first range, controlling the display 160 or 220 to display a first screen in the first area 221 among the plurality of areas, and not to display a screen in a second area 222 and a third area 223 among the plurality of areas. The operation of controlling the display 160 or 220 may include an operation of, based on the sensing value being included in a second range, controlling the display 160 or 220 to display a second screen in the second area 222, and not to display a screen in the first area 221 and the third area 223. The operation of controlling the display 160 or 220 may include an operation of, based on the sensing value being included in a third range, controlling the display 160 or 220 to display a third screen in the third area 223, and not to display a screen in the first area 221 and the second area 222.

According to an embodiment, the operation of controlling the display 160 or 220 may include an operation of, based on the sensing value being included in the first range, controlling the display 160 or 220 to display the first screen in the first area 221 in a first direction. The operation of controlling the display 160 or 220 may include an operation of, based on the sensing value being included in the second range, controlling the display 160 or 220 to display the second screen in the second area 222 in a second direction different from the first direction. The operation of controlling the display 160 or 220 may include an operation of, based on the sensing value being included in the third range, controlling the display 160 or 220 to display the third screen in the third area 223 in the second direction.

According to an embodiment, the first sensor 176 or 601 may include a gyro sensor 176 or 601. The at least one operation may include an operation of detecting or identifying a rotation of the electronic device 101 or 200 by using the gyro sensor 176 or 601. The operation of controlling the display 160 or 220 may include an operation of, based on a sensing value of the gyro sensor 176 or 601 related to the rotation being included in a first rotation range, controlling the display 160 or 220 to display the first screen corresponding to a first event in the first area 221 in the first direction.

According to an embodiment, the second sensor 176 or 602 may include an acceleration sensor 176 or 602. The at least one operation may include an operation of detecting or identifying a movement of the electronic device 101 or 200 by using the acceleration sensor 176 or 602. The operation of controlling the display 160 or 220 may include an operation of, based on a sensing value of the acceleration sensor 176 or 602 related to the acceleration being included in a first acceleration range, controlling the display 160 or 220 to display the second screen corresponding to a second event in the second area 222 in the second direction.

According to an embodiment, the operation of controlling the display 160 or 220 may include an operation of, based on a sensing value of the gyro sensor 176 or 601 related to the rotation being included in a second rotation range, controlling the display 160 or 220 to display the third screen corresponding to a third event in the third area 223 in the second direction.

According to an embodiment, the at least one operation may include an operation of, based on a user setting, selecting display directions of screens respectively corresponding to the plurality of areas of the display 160 or 220. The operation of controlling the display 160 or 220 may include an operation of, based on the selected display directions, controlling the display 160 or 220 to display a screen in at least one area among the plurality of areas.

According to an embodiment, the operation of controlling the display 160 or 220 may include an operation of, based on a first setting being selected by a user input, controlling the display 160 or 220 to display the screen corresponding to a first event in the first area 221. The operation of controlling the display 160 or 220 may include an operation of, based on a second setting being selected by a user input, controlling the display 160 or 220 to display the screen corresponding to the first event in the second area 222.

According to an embodiment, the operation of controlling the display 160 or 220 may include an operation of, based on the event being identified as an event for displaying a screen of a designated application, controlling the display 160 or 220 to display the screen of the designated application on a whole of the display 160 or 220 in a display direction corresponding to the designated application.

According to an embodiment, the operation of controlling the display 160 or 220 may include an operation of, based on the event being identified as an event for displaying a screen of a message application, controlling the display 160 or 220 to display the screen of the message application on the whole of the display 160 or 220 in a first display direction corresponding to the message application. The operation of controlling the display 160 or 220 may include an operation of, based on the event being identified as an event for displaying a screen of a map application, control the display 160 or 220 to display the screen of the map application on the whole of the display 160 or 220 in a second display direction corresponding to the map application.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It would be understood that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one selected from A and B," "at least one of A or B," "A, B, or C," "at least one of A, B, and C," "at least one selected from A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device). For example, a processor (e.g., the controller) of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic device comprising:
a housing;
a flexible display disposed on the housing;
a strap connected to the housing and configured to attach the electronic device to a wrist of a user;
a first sensor configured to detect or identify a rotation of the electronic device, when the electronic device rotates based on a rotation of the wrist of the user;
a second sensor configured to detect or identify a movement of the electronic device, when the electronic device moves based on a movement of a arm of the user;
a processor; and
memory storing instructions that, when executed by the processor, are configured to cause the electronic device to:
obtain a sensing value using the first sensor or the second sensor, in a state that the electronic device is attached to the wrist of the user by the strap
identify an event requesting display of a screen on the display, and
control the display, among a plurality of areas of the display, to display a screen corresponding to the event in an area corresponding to the sensing value, based on the sensing value.

2. The electronic device of claim 1, wherein the instructions, when executed by the processor, are configured to cause the electronic device to:
control the display, among the plurality of areas of the display, not to display a screen in an area not corresponding to the sensing value.

3. The electronic device of claim 1, wherein the display includes a first area which displays a screen in a first display direction, and includes at least one area in which a display direction of a screen can be changed to a second display direction different from the first display direction.

4. The electronic device of claim 1, wherein the instructions, when executed by the processor, are configured to cause the electronic device to:
based on the sensing value being included in a first range, control the display to display a first screen in a first area among the plurality of areas, and not to display a screen in a second area and a third area among the plurality of areas,
based on the sensing value being included in a second range, control the display to display a second screen in the second area, and not to display a screen in the first area and the third area, and
based on the sensing value being included in a third range, control the display to display a third screen in the third area among the plurality of areas, and not to display a screen in the first area and the second area.

5. The electronic device of claim 4, wherein the instructions, when executed by the processor, are configured to cause the electronic device to:
based on the sensing value being included in the first range, control the display to display the first screen in the first area in a first direction,
based on the sensing value being included in the second range, control the display to display the second screen in the second area in a second direction different from the first direction, and
based on the sensing value being included in the third range, control the display to display the third screen in the third area in the second direction.

6. The electronic device of claim 5, wherein the first sensor includes a gyro sensor, and
wherein the instructions, when executed by the processor, are configured to cause the electronic device to:
detect or identify a rotation of the electronic device using the third area, and
based on a sensing value of the gyro sensor related to the rotation being included in a first rotation range, control the display to display the first screen corresponding to a first event in the first area in the first direction.

7. The electronic device of claim 5, wherein the second sensor includes an acceleration sensor, and
wherein the instructions, when executed by the processor, are configured to cause the electronic device to:
detect or identify a movement of the electronic device using the acceleration sensor, and
based on a sensing value of the acceleration sensor related to the movement being included in a first acceleration range, control the display to display the second screen corresponding to a second event in the second area in the second direction.

8. The electronic device of claim 6, wherein the instructions, when executed by the processor, are configured to cause the electronic device to:
based on the sensing value of the gyro sensor related to the rotation being included in a second rotation range, control the display to display the third screen corresponding to a third event in the third area in the second direction.

9. The electronic device of claim 1, wherein the instructions, when executed by the processor, are configured to cause the electronic device to:
based on a user setting, select display directions of screens respectively corresponding to the plurality of areas of the display,
based on the selected display directions, control the display to display a screen in at least one area among the plurality of areas.

10. The electronic device of claim 1, wherein the instructions, when executed by the processor, are configured to cause the electronic device to:
based on a first setting being selected by a user input, control the display to display a screen corresponding to a first event in the first area, and
based on a second setting being selected by the user input, control the display to display the screen corresponding to the first event in the second area.

11. The electronic device of claim 1, wherein the instructions, when executed by the processor, are configured to cause the electronic device to:
based on the event being identified as an event for displaying a screen of a designated application, control the display to display the screen of the designated application on a whole of the display in a display direction corresponding to the designated application.

12. The electronic device of claim 11, wherein the instructions, when executed by the processor, are configured to cause the electronic device to:
based on the event being identified as an event for displaying a screen of a message application, control the display to display the screen of the message application on the whole of the display in a first direction corresponding to the message application, and
based on the event being identified as an event for displaying a screen of a map application, control the display to display the screen of the map application on the whole of the display in a second direction corresponding to the map application.

13. An operating method of an electronic device, the method comprising:
obtaining a sensing value by using a first sensor or a second sensor of the electronic device in a state where the electronic device is attached to a wrist of a user by a strap of the electronic device, wherein the first sensor is a sensor configured to detect or identify a rotation of the electronic device in case that the electronic device is rotated based on a rotation of the wrist of the user, and the second sensor is a sensor configured to detect or identify a movement of the electronic device in case that the electronic device is moved based on a movement of an arm of the user;
identifying an event requesting display of a screen on a display of the electronic device; and
controlling the display to display a screen corresponding to the event in an area corresponding to the sensing value among a plurality of areas of the display, based on the sensing value.

14. The method of claim 13, comprising controlling the display not to display a screen in an area not corresponding to the sensing value among the plurality of areas of the display.

15. A non-transitory computer-readable recording medium storing instructions configured to cause a processor of an electronic device to perform at least one operation, wherein the at least one operation comprises:
obtaining a sensing value by using a first sensor or a second sensor of the electronic device in a state where the electronic device is attached to a wrist of a user by a strap of the electronic device, wherein the first sensor is a sensor configured to detect or identify a rotation of the electronic device in case that the electronic device is rotated based on a rotation of the wrist of the user, and the second sensor is a sensor configured to detect or identify a movement of the electronic device in case that the electronic device is moved based on a movement of an arm of the user;
identifying an event requesting display of a screen on a display of the electronic device; and
controlling the display to display a screen corresponding to the event in an area corresponding to the sensing value among a plurality of areas of the display, based on the sensing value.
